(19) United States
(12) Patent Application Publication
(10) Pub. No.: US 2022/0166623 A1
(43) Pub. Date: May 26, 2022

(54) HARDWARE AUTHENTICATION TOKEN WITH REMOTE VALIDATION

(71) Applicant: COPSONIC, Montauban (FR)

(72) Inventors: Ruben ALFONSO REYES, Montbeton (FR); Carlos David PILOTO FONSECA, Montauban (FR)

(21) Appl. No.: 17/605,689

(22) PCT Filed: Apr. 24, 2020
(86) PCT No.: PCT/FR2020/050702

§ 371 Date: Oct. 22, 2021

(30) Foreign Application Priority Data
Apr. 25, 2019 (FR) 1904394

(51) Int. Cl. H04L 9/32; H04L 9/08; H04L 9/30; G06F 21/34

(52) U.S. Cl. CPC H04L 9/3213; G06F 21/34; H04L 9/3073; H04L 9/0825

(57) ABSTRACT

A hardware authentication token is intended for being connected to a computer terminal. This token includes a confirmation button, a processor and a secure memory area where a first private key is stored. The terminal can ask the user to authenticate using the token by transmitting a first nonce to the user. After the confirmation button has been pressed, the token generates a second nonce, encodes it using ultrasonic signals and transmits it, via an acoustic channel, to the user's smartphone. The token determines from the response whether the second nonce has been signed with a second private key belonging to the user and, if so, returns the first nonce encrypted by the first private key to the computer terminal in order to authenticate the user.

### TECHNICAL FIELD

The present invention relates to the general field of hardware authentication devices and more particularly hardware tokens implementing the FIDO 2 protocol (Fast IDentity Online).

### PRIOR ART

Conventionally, securing access to an online service or a website via a computer terminal is carried out using a login and a password entered by the user. However, this access securing is relatively basic due to the facility with which this information can be stolen, in particular by phishing techniques. Different techniques have been proposed to reinforce the security of the access to such services, in particular out-of-band authentication and two-factor authentication.

Out-of-band authentication (OOB) is a strong type of authentication that makes use of a communication channel that is different from the one used for the access in order to provide a second means of authentication. Out-of-band communication channels can be for example connections via email, SMS, etc. to transmit one-time secret codes.

Two-factor authentication (2FA) or more generally multi-factor (MFA) authentication is based on the use of several different technologies such as one-time passwords (OTP) or a PKI infrastructure (Public Key Infrastructure).

The FIDO protocol (Fast IDentity Online) standardised in the framework of the FIDO Alliance uses a PKI infrastructure as second authentication factor. More precisely, according to the FIDO protocol, the user creates a pair of keys consisting of a private key and a public key. The public key is transmitted to the online service and associated with the account of the user. The private key remains stored in the authentication device of the user (the computer terminal itself or for example a USB key connected to the latter).

When the user wants to connect to the online service, they first identify themselves with it using their login. The user then receives a nonce (or challenge) that they sign with their secret key and sends the nonce thus signed back to the online service. The online service can then verify using the public key of the user whether the nonce has been signed by the private key of the latter.

A new version of the FIDO protocol was included in the specifications of the W3C's Web Authentication (WebAuthn). These specifications provide in particular a FIDO U2F mode (Universal Second Factor) that makes use of a hardware token to store the private key—public key pair of the user as described in FIG. 1.

It is assumed that the user has registered beforehand using their terminal 110 with the online service using a login and has authenticated themselves using a password (1^{st} authentication factor). They have also indicated to the service in question that they want to activate the FIDO U2F authentication option and have consequently transmitted to it a public key generated for the service in question.

The private key—public key pair of the user is generated and stored in a hardware token, here a USB key, 130.

When the user wants to access the online service, they first enter their login and their password on the corresponding webpage, 120. The online service also prompts them to authenticate themselves using their second authentication factor (2FA) by transmitting a nonce to them. The user then inserts the USB key into a USB port of their computer then presses on a validation button, 140, of the USB key to sign the nonce in question using their private key. The nonce thus signed is transmitted, via the USB port and the browser, to the on-line service which can then verify, using the public key of the user, whether the latter has indeed signed it with their private key.

It should be noted that the FIDO U2F protocol authorises types of tokens other than a simple USB key, in particular hardware tokens provided with a BLE (Bluetooth Low Energy) or NFC (Near Field Communication) interface.

The FIDO U2F protocol combined with a hardware authentication token offers very good resistance to attacks of the phishing type. USB keys compliant with this protocol (FIDO U2F compliant) are furthermore already available off the shelf (Feitian or YubiKey for example).

The FIDO protocol evolved to make it possible to allow for authentication using a simple hardware token, without having to provide a password (pass wordless). In this new version of the FIDO protocol, the authentication token contains not only the private key—public key pair as described hereinabove but also a PIN code of the user.

The user goes, using the browser, to the site that they wish to access and choses the authentication via authentication token option. The browser then prompts the user to enter their PIN code, the latter is transmitted to the authentication token with the nonce generated beforehand by the online service. If the PIN code corresponds to the one stored in the token, the latter provides the login of the user for the site in question and signs the nonce with the private key, when the user presses the validation button of the token. The browser then transmits to the online service the login of the user as well as the nonce thus signed. The online service gives access to the user, after having verified, using the public key of the user, that the nonce has been signed with their private key.

This new authentication protocol is called FIDO CTAP 2, the acronym CTAP meaning Client To Authenticator Protocol.

The prior protocol, using the token as the second authentication factor (not as the login), FIDO U2F, was renamed FIDO CTAP 1 in order to differentiate it from the new version of the protocol.

The two versions of the FIDO CTAP 1 protocol and FIDO CTAP 2 protocol are now grouped together within the same standard, called FIDO 2 (or W3C WebAuthn). The specifications of the FIDO2 protocol can be found at the URL https://fidoalliance.org/specifications/download/.

A hardware token that is compliant with the FIDO 2 protocol makes it possible to securely connect from any terminal that has a USB port (or even a BLE or NFC interface). On the other hand, a user who has forgotten to remove their USB key could be hacked, this is particularly true in the case of the FIDO CTAP 2 protocol in that the token contains both the login and the private key: it is then sufficient to know the PIN code to have access to the online service. To reduce this risk, it is possible to provide on the USB key itself a biometric sensor such as a fingerprint sensor. However, adding a biometric sensor on the hardware token makes it substantially more complex and expensive.

A purpose of the present invention is consequently to propose a hardware authentication token that is simple and robust, which makes it possible to be authenticated on any terminal provided with a USB port (or even a BLE or NFC interface) without however having the security risks of the prior art.

### Disclosure of the Invention

The present invention is defined by a hardware authentication token intended to be connected to a computer terminal using a USB, BLE or NFC connection, said hardware token including a processor and a secure memory area, the processor being adapted to generate a pair consisting of a first private key and a first public key of a first asymmetric cryptosystem, the first private key being stored in the secure memory area, said token being original in that it further comprises:
an acoustic encoder/decoder using an encoding dictionary S the code words of which are stored in the secure memory area, said code words representing random or pseudo-random ultrasonic signals;
at least one transducer allowing the hardware token to establish an acoustic channel in emission and in reception with a smartphone of the user;
said hardware authentication token being configured to receive a first nonce from said terminal via said connection and, upon reception of the first nonce, to transmit a second nonce, encoded using the dictionary S, to the smartphone of the user, via the acoustic channel, said hardware authentication token being further configured to receive, via the acoustic channel a response from the smartphone;
the processor being adapted to determine, from said response from the smartphone whether the second nonce has been signed with a second private key belonging to the user and, if so, to encrypt the first nonce using the first private key;
said hardware authentication token being configured to return the first nonce thus encrypted to the terminal via said connection in order to authenticate the user.

Typically, the token has the form of a USB key. It can furthermore comprise a confirmation button, the token then not generating and not transmitting a second nonce until having received the first nonce and until after the confirmation button has been actuated.

It can furthermore comprise an indicator light indicating to the user to confirm the generation and the transmission of the second nonce to the smartphone, when the first nonce has been received from the terminal.

Advantageously, is also comprises a loudspeaker and a built-in microphone to emit and receive said ultrasonic signals via the acoustic channel. The present invention also relates to a method for authenticating a user using a hardware authentication token such as defined hereinabove, of a computer terminal and a smartphone, said method being original in that it comprises:
a) a step of transmitting by the computer terminal to the hardware authentication token, an authentication request comprising the first nonce;
b) a temporary storage of the first nonce in a memory area of said hardware authentication token;
c) a step of generating the second nonce upon reception of the first nonce by said hardware authentication token, the second nonce being encoded in the form of a first ultrasonic signal using the encoding dictionary S;
d) a step of transmitting the first ultrasonic signal by the hardware authentication token to the smartphone of the user, via the acoustic channel, the first ultrasonic signal being decoded to provide the second nonce;
e) a step of signing the second nonce using the second private key, by an authentication application opened beforehand on the smartphone of the user, the signature of the second nonce being encoded in the form of a second ultrasonic signal using a second encoding dictionary S′;
f) a step of transmitting the second ultrasonic signal by the smartphone to the hardware authentication token, via the acoustic channel, the second ultrasonic signal being decoded to provide the signature of the second nonce;
g) a step of verifying, by the processor, the signature of the second nonce using the second public key; and in the case of a positive verification:
h) a step of signing, by the processor, the first nonce using the first private key, the signature of the first nonce being transmitted in the form of a response to the terminal to authenticate the user.

When the token is provided with a confirmation button, the user can actuate this button between steps (b) and (c) to trigger the generation of the second nonce and the transmission of the first ultrasonic signal to the smartphone.

Likewise, when the token is provided with an indicator light, the latter indicates to the user the reception of an authentication request in step (b).

Typically, before step (a), the user proceeds with their registration with an access server using a login, the registration phase (A) further comprising the generation of the pair consisting of the first private key and the first public key by the hardware authentication token, the registration of said first public key with the server, in relation with the login of the user and the storage of the first private key in the secure memory area of said token.

Likewise, prior to step (a), the user proceeds with associating the hardware authentication token with the smartphone, the association phase (B) further comprising the generation of the pair consisting of the second private key and the second public key by an authentication application of the smartphone, the second public key being transmitted via the acoustic channel to the token to be stored there in a memory area, the second private key being stored in a secure memory area of the SIM card of the smartphone.

Advantageously, subsequent to step (h), the terminal enters into a test loop by transmitting at each iteration of said loop a first test nonce to the hardware authentication token, and the latter automatically generates a second test nonce for the current iteration, the code using the encoding dictionary S in the form of a third ultrasonic signal, then transmits the latter via the acoustic channel to the smartphone of the user, the smartphone of the user decoding the third ultrasonic signal and automatically signing the second test nonce using the second private key, encoding the signature thus obtained using the second encoding dictionary S′ to generate a fourth ultrasonic signal that is transmitted, via the acoustic channel, to the hardware authentication token, said token verifying using the second public key whether the second test nonce has been signed using the second private key and, if so, signing the first test nonce using the first private key and transmitting the signature thus obtained to the terminal.

In this case, the terminal can verify that the first test nonce has been signed using the first private key and, if so, generates a new first test nonce at the following iteration, and, if not, informs the access server of this.

### BRIEF DESCRIPTION OF THE DRAWINGS

Other characteristics and advantages of the invention shall appear when reading a preferred embodiment of the invention, described in reference to the accompanying figures among which:

FIG. 1, already described, schematically shows a computer terminal to which a hardware authentication token that is compliant with FIDO 2 protocol is connected, known from the prior art;

FIG. 2 schematically shows a computer terminal to which a hardware authentication token is connected according to an embodiment of the invention, in communication with the smartphone of a user;

FIG. 3 schematically shows the architecture of a hardware authentication token according to an embodiment of the invention.

FIG. 4 schematically shows the exchanges between the terminal, the hardware authentication token and the smartphone of FIG. 2 during an authentication procedure of the user.

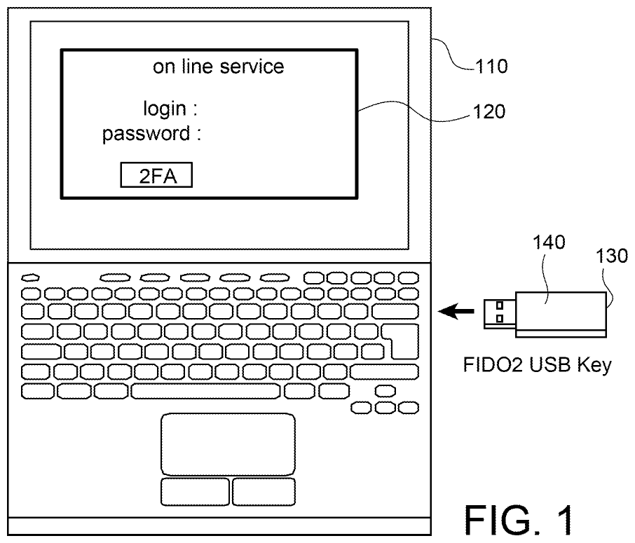

### DETAILED DISCLOSURE OF PARTICULAR EMBODIMENTS

A hardware authentication token that is compliant with the FIDO 2 protocol shall be considered in what follows. In other terms, this hardware token allows its owner to prove their identity using an authentication factor (first, second or multiple). This hardware token includes an interface allowing them to be connected to a computer terminal (personal computer, laptop, phablet, etc.) using a USB, BLE or NFC connection.

According to a preferred embodiment, the hardware authentication token will have the form of a USB key that has specific characteristics, as described hereinafter.

The idea at the base of the invention if to offset to a smartphone the validation button of the hardware authentication token. This transfer is made possible thanks to an acoustic channel established between the hardware authentication token and the smartphone, the transmission on this canal using information coding using a dictionary of which the code words are random or pseudo-random signals.

As detailed hereinafter, the authentication procedure requires being in possession both of the hardware authentication token and of the smartphone of the user (in additional to the knowledge of the login/password pair in FIDO CTAP 1 or of the PIN code in FIDO CTAP 2). The probability that this user forgets their smartphone and leaves the hardware authentication token connected to the terminal is particularly low. The risk of hacking is therefore, a fortiori, particularly reduced, when the smartphone is locked by a biometric sensor or a PIN code.

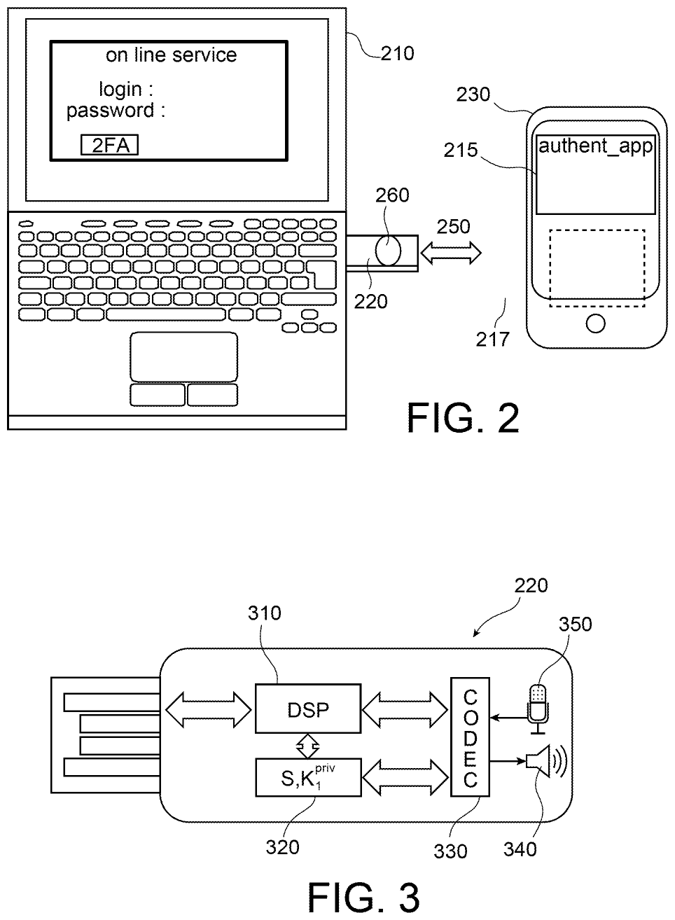

More precisely, FIG. 2 shows a case of use of the hardware authentication token according to an embodiment of the invention.

The use case shown here is a user who wants to connect to an online service using their personal computer, 210. Of course, other use cases can be considered by a person skilled in the art without leaving the scope of the present invention. In particular, the user can authenticate themselves using their hardware authentication token with an access terminal.

After having conventionally entered their login and their password (or their PIN code in the FIDO CTAP 2 protocol) on the webpage of the online service in question, the user is prompted to provide a (first or second) authentication factor using a hardware token. This assumes that, for example, during the creation of their account therewith (enrolment) or of the registration of their profile, the user had selected beforehand an authentication via hardware token option and registered a public key with the website allowing for this authentication. More precisely, to do this the user generates a pair of keys of an asymmetric encryption cryptosystem (or a PKI infrastructure) consisting of a first private key and a first public key. For example, this cryptosystem can be one with elliptic curve cryptography (ECC) known per se. In any case, only this first public key will be provided to the server of the online service and stored with the profile of the user.

If the user has selected the authentication using a hardware token option, they can be prompted by the online site to present their hardware authentication token.

The user then connects their authentication token 220, by plugging it into a USB port of the computer terminal (by activating the Bluetooth connection if the token has a BLE interface, by bringing the token close to the NFC reader if the token has an NFC interface).

The authentication token further comprises a processor (DSP), 310 as well as a secure memory area, 320, such as shown in FIG. 3.

In an original manner, the hardware authentication token 220 comprises an acoustic encoder/decoder 330 using an encoding dictionary (codebook) S comprised of code words representing random or pseudo-random ultrasonic signals as described in the application published under number FR-A-3052614. According to an alternative a first encoding dictionary S is used for the emission and a second encoding dictionary S′ is used for reception by the token.

The acoustic encoder/decoder is advantageously implemented by software means in the DSP. Alternatively, they can be implemented by a separate circuit, 330, of the latter.

In any case, the code words of the encoding dictionary (or even dictionaries) are stored in the secure memory area, 320, for example the memory of the processor itself when the acoustic coding/decoding is carried out by the DSP. This secure memory area also contains the aforementioned first private key.

Finally, the hardware authentication token includes at least one transducer making it possible to establish an acoustic channel in emission and in reception with a smartphone of the user, 230. A single transducer can suffice when the code words used by the hardware authentication token (code words of the dictionary S) and those used by the smartphone (code words of the dictionary S′) to transmit on the acoustic channel are weakly correlated and consequently authorise a use of the channel in full duplex mode. The transducer can for example be of the piezoelectric type. Alternatively, as shown in FIG. 3, a built-in loudspeaker 340 and microphone 350 can be provided to respectively emit and receive on the acoustic channel.

Once the hardware authentication token 220 is connected, the latter receives from the terminal 210 a first nonce generated by the access server of the online service. In the FIDO CTAP 1 protocol, the first nonce can be for example calculated as the hash of the account number of the user concatenated with a temporal piece of information.

Upon reception of this first nonce, the token generates a second nonce and the code using the encoding dictionary S. Generating the second nonce can be automatic, when the first nonce is received. Preferably, however, the second nonce will be generated only after pressing a confirmation button, 260. The reception of the first nonce by the hardware authentication token can be reported to the user by a blinking lighted signal, for example by a blinking ring of light produced by a ring of LEDs, surrounding the confirmation button.

The second nonce can be identical to the first nonce. According to a preferred alternative, the second nonce will result from the concatenation of the first nonce with a serial number of the hardware token in question. In any case, the second nonce thus encoded has the form of an ultrasonic signal that is transmitted to the smartphone, 230, of the user via the acoustic channel, 250. The smartphone decodes the ultrasonic signal using the encoding dictionary S and thus retrieves the second nonce.

The user can then authenticate themselves by signing, using their smartphone, 230, the second nonce using a second private key. For this purpose, the user will have downloaded beforehand an authentication application, 215 on their smartphone. Signing using the smartphone can for example be triggered by pressing a (tactile) validation button, the carrying out of a particular movement, after the authentication application has prompted the user (owner of the smartphone) to validate their authentication.

This authentication application has access to a second asymmetric encryption cryptosystem, consisting of a second private key and of a second public key, the second private key being retained in a secure memory area of the smartphone, for example in a secure area or TEE (Trusted Execution Environment) of the SIM card of the smartphone. It is essential to note that the second private key is specific to the user.

It is assumed that the second public key has been provided by the smartphone to the hardware authentication token, for example during a prior association procedure as described hereinafter.

The signature of the second nonce is encoded using an encoding dictionary S′ that can be identical to the dictionary S and the resulting ultrasonic signal is transmitted to the hardware authentication token via the acoustic channel.

The ultrasonic signal received by the transducer (or the built-in microphone 350) of the token is decoded by the acoustic decoder (using the dictionary S′ also stored in said secure memory area of the token) in order to retrieve the signature. The processor then determines using the second public key whether the second nonce has been signed by the second private key. If so, it signs in turn the first nonce using the first private key and transmits this signature to the terminal. When it exists, the ring of LEDS around the confirmation button 260 can then switch to a permanent lighted state to confirm to the user that the signature of the second nonce is indeed valid.

The terminal finally sends the signature of the first nonce (also called assertion) back to the access server of the online service and the latter verifies that the first nonce has been signed by the first private key.

Note that the first private key is specific to the hardware authentication token and is not specific to the user. In other terms, losing the authentication token will have no consequence on the access security to the online service. Only the joint possession of the hardware authentication token and of the smartphone allows access to the service in question. And it would furthermore be necessary for the hacker to have also procured the login and the password of the user in order to get through the first identification step (knowledge of the PIN code being sufficient in the case of the FIDO CTAP 2 protocol).

Using an acoustic channel between the hardware encryption token and the smartphone substantially reduces the risks of interception and of attacks of the man-in-the-middle type due to the low range of the ultrasonic signals. Furthermore, transmission on this channel using random or pseudo-random acoustic signals substantially reinforces the robustness of the channel to such attacks.

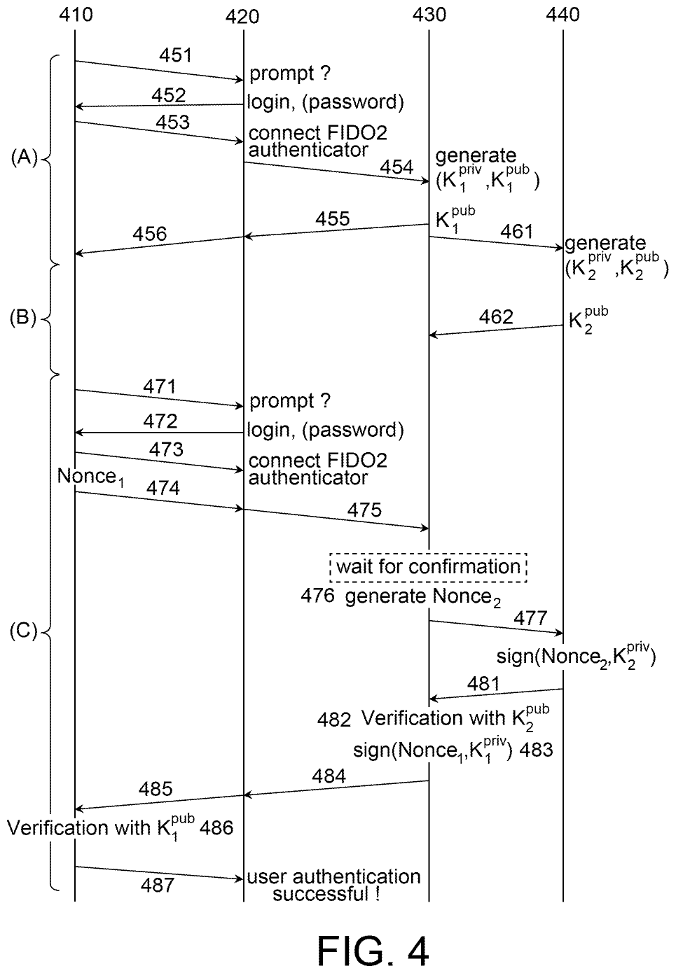

FIG. 4 schematically shows the exchanges between the terminal, the hardware authentication token and the smartphone of FIG. 2 during an authentication procedure of the user.

The authentication procedure (C) supposes that the first public key of the token has been registered beforehand with the access server in relation with the account of the user (registration procedure A) and that the second public key of the user has been registered beforehand in the hardware authentication token (association procedure B).

The server of the online service, the computer terminal, the hardware authentication token and the smartphone of the user are respectively represented by the vertical lines 410, 420, 430 and 440.

In the registration procedure (A), when the user creates the account with the access server, the latter prompts them in 451 to provide it in 452 with a login and a password.

If the user has selected the option for an authentication via a hardware token (FIDO 2 authenticator) to access their account, they are prompted in 453 to connect the hardware authentication token to the terminal. In 454, the terminal requests that the token generate a pair of an asymmetric cryptosystem consisting of a first private key and a first public key. The first private key, K₁^{priv}, is stored in the protected memory area of the token while the first public key, K₁^{pub} is provided to the terminal in 455, then transmitted to the access server in 456. The access server associates the first public key with the login and, where applicable, with the password of the user. Advantageously, the first public key is not provided automatically to the terminal via a simple request but requires the actuating of the button, when it is present on the token. Preferably, the user will have to press the button for a different amount of time (for example substantially longer) than when they confirm the transfer of the second nonce to the smartphone.

In the association procedure (B), the authentication token is connected to the computer terminal. From a control window or, if the token is provided with a button, by pressing for example for a long time on the latter, the token generates in 461 a request on the acoustic channel. As the authentication application of the smartphone has been opened, the latter generates upon reception of the request signal a pair of an asymmetric cryptosystem consisting of a second private key, K₂^{priv}, and of a second public key, K₂^{pub}. The second private key is stored for example in a secure area (TEE) of the SIM card while the second public key, K₂^{pub}, is transmitted in 462 to the token via the acoustic channel. This second public key is stored in a memory area of the token (not necessarily the secure area). If the token is single-user only the second public key is stored. On the other hand, if the authentication token can be shared between several users, a login of the user of the smartphone can be stored in association with the corresponding second public key in the memory area. Here again, the operation of storing the second public key may not be automatic but require a button to be actuated (optional) of the token.

Finally in the authentication procedure strictly speaking (C), the user is firstly prompted in 471 to identify themselves.

As a response, the user enters (in the framework of the FIDO CTAP 1 protocol) their login and their password in the key-entry window of the browser and the latter transmits them in 472 to the access server. After having received this information, the access server prompts in 473 the user to provide their (first, second, nth) authentication factor by connecting their hardware authentication token to the terminal.

The access server then transmits a first nonce, Nonce₁, in 474 to the terminal. As indicated hereinabove, this nonce can result from the concatenation of the account number of the user with a temporal piece of information in such a way as to prevent replay attacks. The terminal forwards it in 475 to the hardware authentication token.

In the case of a FIDO CTAP 2 protocol, recall that the user enters only their PIN code in the browser window and that the first nonce is transmitted with the PIN code to the hardware authentication token.

At this stage, two alternatives are possible. According to a first alternative not shown, the token automatically generates in 476 a second nonce, Nonce₂, and transmits it in 477 to the smartphone after having encoded it using the encoding dictionary S. According to a second alternative, wherein the token is provided with a confirmation button, the token waits for the button to be pressed to generate the second nonce in 476.

The second nonce can be a copy of the first nonce or result from the concatenation of the latter with a serial number of the token.

In any case, the second nonce is encoded using the encoding dictionary S and transmitted in the form of an ultrasonic signal to the smartphone via the acoustic channel. It is assumed moreover that the user has opened the authentication application on their smartphone (for example before having pressed the confirmation button of the token) or that the latter was automatically launched when the second nonce was received. The application of the smartphone then decodes the ultrasonic signal in order to retrieve the second nonce and signs it with its private key, which is sign(Nonce₂, K₂^{priv}), then encodes this signature with its encoding dictionary S′.

In step 481, the smartphone transmits, via the acoustic channel, an ultrasonic signal corresponding to the signature sign(Nonce₂, K₂^{priv}) thus encoded. This signal is received and decoded by the acoustic decoder (or the DSP) of the token.

In 482, the token verifies, using the second public key K₂^{pub}, that the signature is indeed valid, in other words that the second nonce has been signed by the second private key.

If not, the token can report this to the terminal or simply not respond to the terminal. In case a failure message is received or at the end of a predetermined length of time (timeout), the terminal indicates to the user that the authentication using the token has failed.

If so, the token and, more precisely its processor, signs the first nonce (that had been put on hold in a buffer) using the first private key K₁^{priv}, which is sign(Nonce₁, K₁^{priv}) in 483, then transmits this signature to the terminal in 484 which forwards it in 485 to the access server. The latter verifies in 486, using the first public key K₁^{pub}, that this signature is indeed valid, in other words that the first nonce has been signed by the first private key K₁^{priv}.

If not, the server informs the terminal of the failure of the authentication and prompts, where applicable, the user to reiterate the authentication procedure.

If so, the server allows in 487 the user to access the service in question.

Advantageously, in order to ensure that the user does not leave their session open on the computer terminal, a continuous (or periodical) authentication procedure can be initiated by the terminal. This procedure can be launched when the user has received authorisation to access the service.

According to this procedure, the terminal iteratively transmits a first test nonce, periodically or when a predetermined period of time has elapsed since the last reception of a confirmation of the presence of the smartphone of the user. The first test nonce is modified from one iteration to the next in such a way as to combat replay attacks. For example, if Nonce_{ck1}ⁿ denotes the first test nonce that was generated by the terminal at iteration n, the first test nonce at the following iteration can be obtained by Nonce_{ck1}ⁿ⁺¹=hash(Nonce_{ck1}ⁿ∥ctr(n)) where ctr(n) is the output of a counter incremented at each iteration and, where applicable, initialised by a random number at the start of the session, .∥. designates a concatenation operation and hash is a hash function.

During iteration n, the first test nonce, Nonce_{ck1}ⁿ, is transmitted to the hardware authentication token. Upon reception of this nonce, the token stores it in memory and generates a second test nonce, Nonce_{ck2}ⁿ. This second test nonce can be identical to the first or result, for example, from a concatenation of the first with a temporal piece of information. The second test nonce is then transmitted by the authentication token to the smartphone of the user, via the acoustic channel, after having been encoded in the form of ultrasonic signals using the dictionary S, as described hereinabove.

These signals are decoded by the authentication application of the smartphone and the second test nonce Nonce_{ck2}ⁿ is signed by the private key K₂^{priv} stored in the secure area TEE of the smartphone. The signature sign(Nonce_{ck2}ⁿ, K₂^{priv}) is encoded in the form of ultrasonic signals using the encoding dictionary S′ and transmitted to the hardware authentication token via the acoustic channel.

The authentication token, after having decoded the signature in question, verifies using the second public key K₂^{pub}, that the second test nonce has been signed by the private key of the user. If this is indeed the case, it signs in turn the first test nonce using the first private key K₁^{priv}, which is sign(Nonce_{ck1}ⁿ,K₁^{priv}) then transmits this signature to the terminal.

The terminal verifies that this signature is indeed valid, i.e. that the first test nonce of the iteration n, Nonce_{ck1}ⁿ, has been signed by the first private key, K₁^{priv}. If so, the terminal passes to the next iteration by sending a new test nonce Nonce_{ck1}ⁿ⁻¹.

A person skilled in the art will understand that this test loop makes it possible to ensure that the smartphone of the user and the authentication token are still present. If a rupture occurs in the authentication chain, the first or the second test nonce is not sent back within a predetermined period of time. The terminal then informs the access server of this and the user is automatically disconnected from the online service.

It should be noted that the continuous authentication procedure assumes that the confirmation by the user is ignored. In other terms, the user does not have to press the confirmation button at each authentication request: generating the second test nonce is carried out automatically. Likewise, the signing by the smartphone is automatic and does not require a validation action from the user at each iteration. This automatic mode can be reported using a particular prefix of the nonce in question.

The continuous authentication procedure described hereinabove is initiated and controlled by the terminal, in that it transmits the first test nonces and verifies the signatures. However, according to an alternative, this authentication procedure can be carried out by the access server itself. In this case, upon reception of an erroneous response or in the absence of a response during a predetermined period of time, the server closes the session.

Finally, the present invention has been described in the framework of access to an online service. A person skilled in the art will understand however that it can also be applied to allow for access to a session of the terminal itself, the terminal then playing the role of the access server. Similarly, in this case here, the terminal can also proceed with a continuous authentication using the hardware authentication token and close the session opened on the terminal in case an erroneous response is received or absence of a response for a predetermined period of time.

What is claimed is:

1. Hardware authentication token intended to be connected to a computer terminal using a USB, BLE or NFC connection, said hardware authentication token comprising:
a processor and a secure memory area, the processor being adapted to generate a pair consisting of a first private key and a first public key of a first asymmetric cryptosystem, the first private key being stored in the secure memory are:
an acoustic encoder/decoder using an encoding dictionary S the code words of which are stored in the secure memory area, said code words representing random or pseudo-random ultrasonic signals; and
at least one transducer allowing the hardware token to establish an acoustic channel in emission and in reception with a smartphone of the user,
wherein said hardware authentication token being configured to receive a first nonce from said terminal via said connection and, upon reception of the first nonce, to transmit a second nonce, encoded using the dictionary S, to the smartphone of the user, via the acoustic channel, said hardware authentication token being further configured to receive, via the acoustic channel a response from the smartphone,
wherein the processor being adapted to determine, from said response from the smartphone whether the second nonce has been signed with a second private key belonging to the user and, if so, to encrypt the first nonce using the first private key, and
wherein said hardware authentication token being configured to return the first nonce thus encrypted to the terminal via said connection in order to authenticate the user.

2. Hardware authentication token according to claim 1, wherein the hardware authentication token has the form of a USB key.

3. Hardware authentication token according to claim 1, further comprising a confirmation button, the token then not generating and not transmitting a second nonce until having received the first nonce and until after the confirmation button has been actuated.

4. Hardware authentication token according to claim 3, further comprising an indicator light indicating to the user to confirm the generation and the transmission of the second nonce to the smartphone, when the first nonce has been received from the terminal.

5. Hardware authentication token according to claim 1, further comprising a loudspeaker and a built-in microphone to emit and receive said ultrasonic signals via the acoustic channel.

6. Method for authenticating a user using a hardware authentication token according to claim 1, of a computer terminal and a smartphone, the method comprising:
a) a step of transmitting by the computer terminal to the hardware authentication token, an authentication request comprising the first nonce;
b) a temporary storage of the first nonce in a memory area of said hardware authentication token;
c) a step of generating the second nonce upon reception of the first nonce by said hardware authentication token, the second nonce being encoded in the form of a first ultrasonic signal using the encoding dictionary S;
d) a step of transmitting the first ultrasonic signal by the hardware authentication token to the smartphone of the user, via the acoustic channel, the first ultrasonic signal being decoded to provide the second nonce;
e) a step of signing the second nonce using the second private key, by an authentication application opened beforehand on the smartphone of the user, the signature of the second nonce being encoded in the form of a second ultrasonic signal using a second encoding dictionary S′;
f) a step of transmitting the second ultrasonic signal by the smartphone to the hardware authentication token, via the acoustic channel, the second ultrasonic signal being decoded to provide the signature of the second nonce;
g) a step of verifying, by the processor, the signature of the second nonce using the second public key; and in the case of a positive verification:
h) a step of signing, by the processor, the first nonce using the first private key, the signature of the first nonce being transmitted in the form of a response to the terminal to authenticate the user.

7. Method for authenticating a user according to claim 6, wherein, as the token is provided with a confirmation button, the user actuates this button between steps (b) and (c) to trigger the generation of the second nonce and the transmission of the first ultrasonic signal to the smartphone.

8. Method for authenticating a user according to claim 7, wherein, as the hardware authentication token is provided with an indicator light, the latter indicates to the user the reception of an authentication request in step (b).

9. Method for authenticating a user according to claim 5, wherein, prior to step (a), the user proceeds with their registration with an access server using a login, the registration phase (A) further comprising the generation of the pair consisting of the first private key and the first public key by the hardware authentication token, the registration of said first public key with the server, in relation with the login of the user and the storage of the first private key in the secure memory area of said token.

10. Method for authenticating a user according to claim 5, wherein, prior to step (a), the user proceeds with associating the hardware authentication token with the smartphone, the association phase (B) further comprising the generation of the pair consisting of the second private key and the second public key by an authentication application of the smartphone, the second public key being transmitted via the acoustic channel to the token to be stored there in a memory area, the second private key being stored in a secure memory area of the SIM card of the smartphone.

11. Method for authenticating a user according to claim 5, wherein, subsequent to step (h), the terminal enters into a test loop by transmitting at each iteration of said loop a first test nonce to the hardware authentication token, and that the latter automatically generates a second test nonce for the current iteration, the code using the encoding dictionary S in the form of a third ultrasonic signal, then transmits the latter via the acoustic channel to the smartphone of the user, the smartphone of the user decoding the third ultrasonic signal and automatically signing the second test nonce using the second private key, encoding the signature thus obtained using the second encoding dictionary S′ to generate a fourth ultrasonic signal that is transmitted, via the acoustic channel, to the hardware authentication token, said token verifying using the second public key whether the second test nonce has been signed using the second private key and, if so, signing the first test nonce using the first private key and transmitting the signature thus obtained to the terminal.

12. Method for authenticating a user according to claim 11, wherein the terminal verifies that the first test nonce has been signed using the first private key and, if so, generates a new first test nonce at the following iteration, and, if not, informs the access server of this.
